(19) United States
(12) Patent Application Publication
(10) Pub. No.: US 2008/0202708 A1
(43) Pub. Date: Aug. 28, 2008

(54) RETRACTABLE DOOR ASSEMBLY FOR PORTABLE SHELTER

(76) Inventor: Glenn OPENDO, Notre-Dame-de-I'lle-Perrot (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/038,308

(22) Filed: Feb. 27, 2008

Related U.S. Application Data
(60) Provisional application No. 60/891,803, filed on Feb. 27, 2007.

(51) Int. Cl. E06B 9/68; E04H 15/58

(52) U.S. Cl. 160/310; 135/117

(57) ABSTRACT

A retractable door assembly for an entrance/exit of a portable shelter comprises a door having a panel of flexible material. The door is rolled onto the support rod. Supports are operatively connected to ends of the support rod and are adapted to connect the support rod on a structure of the portable shelter with respect to the entrance/exit of the portable shelter, such that the support rod is rotatable about its longitudinal axis. An actuator system is operatively connected to the support rod to actuate a rotation of the support rod to deploy the door to close the entrance/exit and retract the door to free the entrance/exit of the portable shelter.

### CROSS-REFERENCE TO RELATED APPLICATION

This patent application claims priority on U.S. Provisional Patent Application No. 60/891,803, filed on Feb. 27, 2007, by the present applicant.

### BACKGROUND OF THE APPLICATION

1. Field of the Application

The present application relates to portable shelters used as alternatives to garages for vehicles, and more particularly to a door assembly for such portable shelters.

2. Background Art

Portable shelters for vehicles have been developed as an alternative to garages. For car owners who do not have access to a garage, a portable shelter allows the car to be protected from snow and from the sun, amongst other elements. In severe winter climates, a portable shelter conveniently protects the car from snow, saving the car user some time, as the time required to shovel the driveway and brush the snow off the car is greatly reduced.

However, a garage has the advantage of being closeable. As such, snow cannot be blown into the garage in windy and snowy conditions, the garage can be heated, and items can be concealed in the garage.

### SUMMARY OF APPLICATION

It is therefore an aim of the present application to provide a portable shelter that addresses issues associated with the prior art.

Therefore, in accordance with the present application, there is provided a retractable door assembly for an entrance/exit of a portable shelter comprising: a door having a panel of flexible material with a first edge and a second edge; at least one support rod, the door being connected to the support rod at the first edge and rolled onto the support rod; supports operatively connected to ends of the support rod and adapted to connect the support rod on a structure of the portable shelter with respect to the entrance/exit of the portable shelter, such that the support rod is rotatable about its longitudinal axis; and an actuator system operatively connected to the support rod to actuate a rotation of the support rod to deploy the door to close the entrance/exit and retract the door to free the entrance/exit of the portable shelter.

Further in accordance with the present application, there is provided a retractable door assembly in combination with a portable shelter comprising: a portable shelter having a structure and flexible panels secured to the structure to define a volume for accommodating at least one vehicle and at least one entrance/exit; and a retractable door assembly comprising a door having a panel of flexible material defining a first edge and a second edge, at least one support rod, the door being connected to the support rod at the first edge and rolled onto the support rod, supports operatively connected to ends of the support rod and adapted to connect the support rod on a structure of the portable shelter with respect to the entrance/exit of the portable shelter, such that the support rod is rotatable about its longitudinal axis, and an actuator system operatively connected to the support rod to actuate a rotation of the support rod to deploy the door to close the entrance/exit and retract the door to free the entrance/exit of the portable shelter.

### BRIEF DESCRIPTION OF THE DRAWINGS

FIG. 1 is a perspective view of a portable shelter in accordance with the prior art;

FIG. 2 is a structure of the portable shelter of FIG. 1;

FIG. 3 is a schematic view of a retractable door assembly in accordance with a first embodiment of the present application, as used with the portable shelter of FIG. 1;

FIG. 4 is a perspective view of a structure of a portable shelter in combination with a retractable door assembly in accordance with a second embodiment of the present application;

FIG. 5 is an enlarged view of the structure and retractable door assembly of FIG. 4; and

FIG. 6 is an enlarged view of the structure and retractable door assembly of FIG. 4, with a tool for manually retracting the door.

### DESCRIPTION OF THE PREFERRED EMBODIMENTS

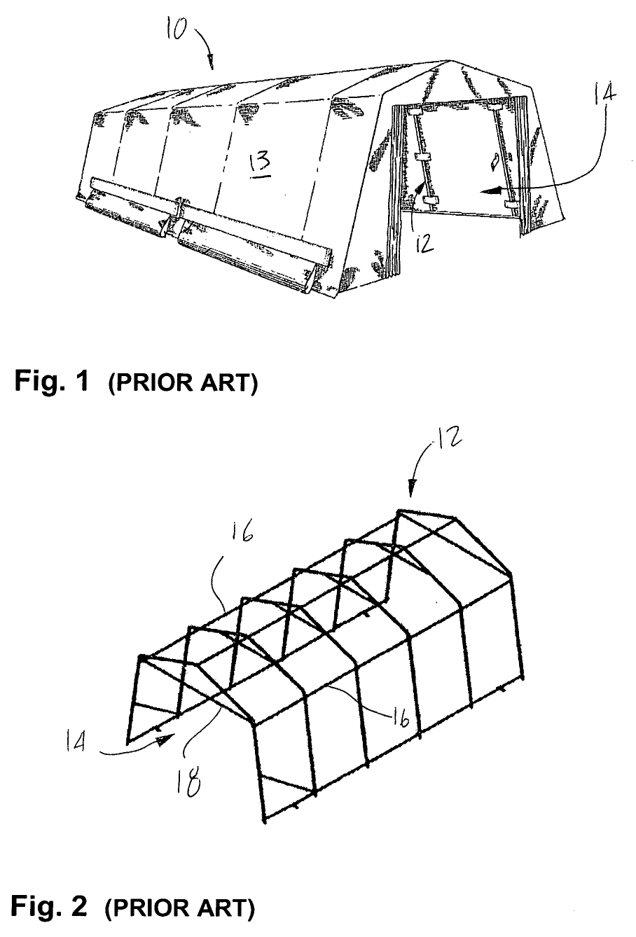

Referring now to the drawings, and more particularly to FIG. 1, a portable shelter or vehicle shelter in accordance with the prior art is generally shown at 10. The portable shelter 10 has a structure 12 upon which a covering 13 is tautened, so as to define the enclosure or volume in which the vehicle is stored. It is pointed out that the shelter 10 can be of different dimensions, for instance to be used to accommodate more than one car, lengthwise or widthwise. The covering 13 is typically made of panels of flexible material (e.g., plastic sheets, reinforced panels, tarp, etc.). The shelter 10 defines an entrance/exit 14 providing access to the portable shelter 10.

Referring to FIG. 2, a typical configuration for the structure 12 of the shelter 10 is illustrated. Amongst structural members, the structure 12 has columns 15, longitudinal beams 16 and transverse beam 18.

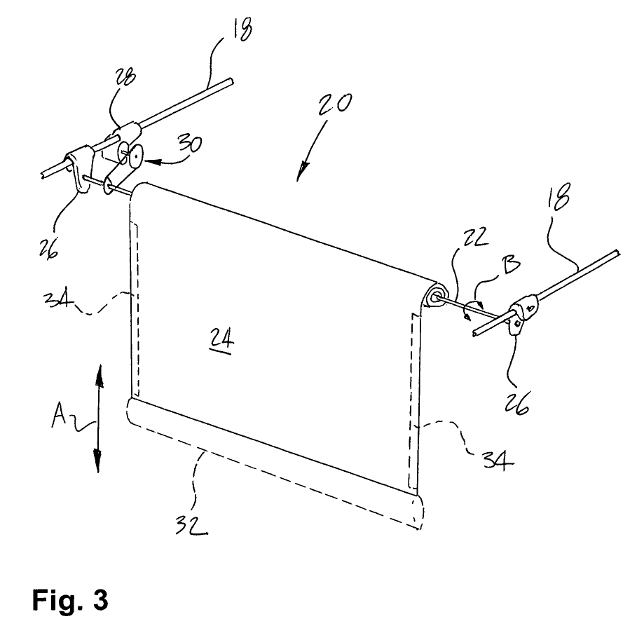

Referring to FIG. 3, a retractable door assembly in accordance with a first embodiment is generally shown at 20. The retractable door assembly 20 is suitably used with portable shelters such as the portable shelter 10 of FIGS. 1 and 2.

In the embodiment of FIG. 3, the retractable door assembly 20 has a support rod 22. A door 24 consisting of a panel of flexible material is rolled around the support rod 22, such that rotations of the support rod 22 about its longitudinal axis retract/deploy the door 24, as illustrated by directions A.

Supports 26 are provided on opposed ends of the support rod 22. In the embodiment of FIG. 3, the supports 26 each enclose bearings so as to allow the rotation of the support rod 22 about its longitudinal axis, as illustrated by directions B. The supports 26 are secured to the structure 12 of the shelter 10, and are, as an example, illustrated as being hooked to the longitudinal beams 16. Fasteners are typically used to ensure that the supports 26 are removably anchored to the structure 12. In another example, the supports 26 are secured to the transverse beam 18 or atop the columns 15, with the rod 22 being spaced enough from the beam 18 to be operable.

An actuation system incorporates the motor 28 that is positioned adjacent to the support rod 22, on the longitudinal beam 16 as well. The motor 28 actuates the rotation of the support rod 22, by way of transmission 30, in either direction. The transmission 30 is, in the embodiment of FIG. 3, a belt with pulleys on the shaft of the motor 28 and on the rod 22. Other transmissions are considered, such as gears or a chain with sprockets, amongst other possibilities. Considering the forces between the motor 28 and the rod 22, the motor 28 must be anchored to the structure 12 to withstand the transmission of forces.

The motor 28 is connected to a power source, such as an adjacent power network. As alternatives, it is considered to provide the actuation system of the retractable door assembly 20 with a rechargeable battery, with for instance solar panels positionable on the outside of the shelter 10 to recharge the battery. The battery is selected so as to provide enough storage to be used as the single source of power for the actuation system.

The motor 28 is preferably provided with a remote control, such that the retraction/deployment of the door 24 can be performed from the vehicle. A remote control using RF signals can suitably be used for wireless communication with the motor 28, such that the door 24 can be retracted from the vehicle.

A ballast 32 is optionally positioned on a bottom edge of the tarp door 24. The ballast 32 provides stability to the door 24 once the door 24 is unrolled to close the entrance 14 of the shelter 10. As an alternative, releasable connectors 34 in the form of Velcro™ strips are provided on the lateral edges of the door 24, to releasably secure the door 24 to complementary strips on the periphery of the entrance 14. The presence of connectors 34 must be taken into consideration if a remote control is used with the retractable door assembly 20. More specifically, all necessary precautions must be taken so as to ensure that the door 24 is not retracted while being secured to the shelter 10, or that the connection forces can be overcome by the action of the motor 28 without damaging the door 24. The ballast 32 advantageously overcomes this problem.

When the ballast 32 is used, the selection of the sizing of the motor 28 must take into account the additional weight of the ballast 32. The anchoring of the retractable door assembly 20 to the structure 12 of the shelter 10 must also be capable of sustaining this additional weight. The ballast 32 typically consists of a pocket in which a readily-accessible material is accommodated (e.g., sand, ice).

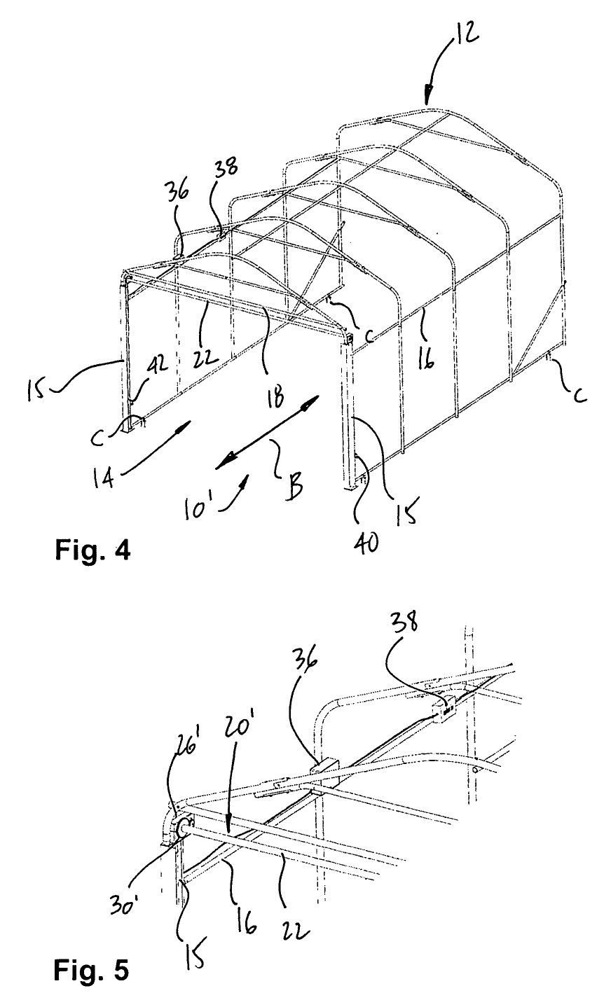

Referring concurrently to FIGS. 4 and 5, a shelter in accordance with another embodiment is generally shown at 10′. The shelter 10′ is similar to the shelter 10 of FIGS. 1 and 2, but is expandable/retractable in directions B. Accordingly, the shelter 10′ is readily deployed or put away in storage, or kept permanently on site in the retracted configuration. Anchoring devices are illustrated at C in FIG. 4, so as to anchor the shelter 10′ to the ground or alternatively to surrounding structural walls. It is considered to have the roof be removable from a remainder of the structure, to facilitate storage of the shelter 10′. It is also considered to provide casters at the bottom of the structure 12 to facilitate the expansion or retraction of the shelter 10′.

The shelter 10′ is used in combination with retractable door assembly 20′. The retractable door assembly 20′ is similar to the retractable door assembly 20, whereby like reference numerals represent like elements. The retractable door assembly 20′ has supports 26′ by which it is anchored atop the columns 15, for instance by being bolted to the columns 15. The supports 26′ support the rod 22, the electric motor 28, as well as gears 30′ which will transmit motion from the electric motor 28 to the rod 22. The supports 26′ support the rod 22 by way of bearings or like member enabling rotation of the rod 22.

A PCB controller 36, a transformer 38 and emitter 40/receiver 42, and a manual switch are provided as part of the actuation system of the retractable door assembly 20′. More specifically, the PCB controller 36 controls the signals received from the remote control and from the detectors (i.e., the emitter 40/receiver 42), so as to control the closing/opening of the door 24. The transformer 38 is provided to ensure a suitable voltage is provided to the motor 28 and to the PCB controller 36. For instance, the motor 28 preferably runs on 24 V voltage. It is pointed out that the transformer 38 may enclosed in the casing of the PCB controller 36.

The retractable door assemblies 20/20′ may be provided in the form of retrofit kits that can be used with existing temporary shelters. In such a use, the support rod 22 is sized as a function of the width of the entrance 14, or may be a telescopic rod adapting to different widths.

As the interior of the portable shelter 10 can be concealed with the door 24, it is considered to provide heating in the portable shelter 10. In such a case, all necessary precautions must be taken, considering that the tarp of the shelter 10 is made of a flammable material.

The retractable door assembly 20/20′ may suitably be used with other types of shelters that have an opened entrance. Moreover, the retractable door assembly 20 may be sold with the shelter 10. Although the retractable door assemblies 20/20′ have been described with the door 24 moving upward/downward in retraction/deployment (FIG. 3), it is considered to provide a retractable door assembly in which the door deploys from one side to another (e.g., left to right), similar to the lateral movement of an elevator door. In such a case, a rail is provided to support a free upper end of the door, so as to guide the door in its movement.

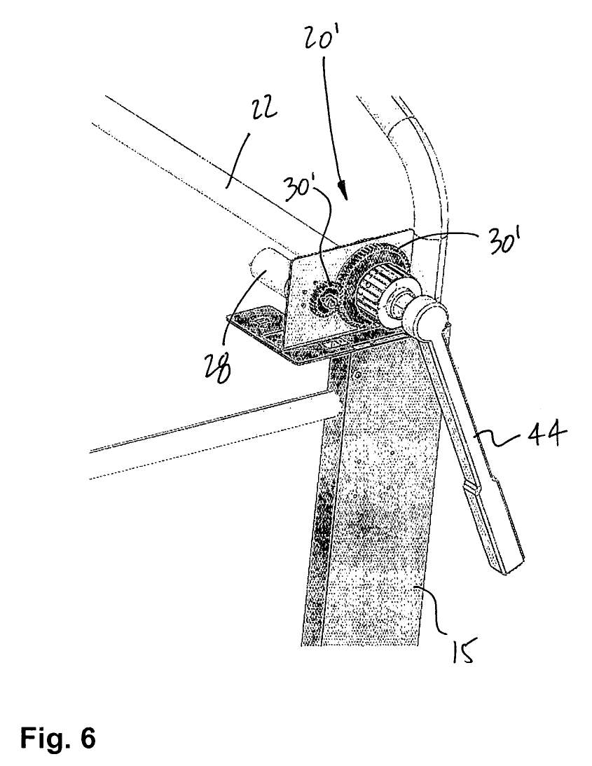

As illustrated in FIG. 6, a manual override is optionally provided to actuate the motor 28 without the remote control. For instance, in the case of a power outage, the ratchet 44 or similar tool is used to open or close the door.

In another embodiment, the door (or doors) is a hinged door, pivoting about a vertical or horizontal axis as actuated by a motor. In the case in which the retractable door assembly has a hinged door, a frame is provided on the periphery of the door to maintain the tarp of the door tautened.

1. A retractable door assembly for an entrance/exit of a portable shelter comprising:
a door having a panel of flexible material with a first edge and a second edge;
at least one support rod, the door being connected to the support rod at the first edge and rolled onto the support rod;
supports operatively connected to ends of the support rod and adapted to connect the support rod on a structure of the portable shelter with respect to the entrance/exit of the portable shelter, such that the support rod is rotatable about its longitudinal axis; and
an actuator system operatively connected to the support rod to actuate a rotation of the support rod to deploy the door to close the entrance/exit and retract the door to free the entrance/exit of the portable shelter.

2. The retractable door assembly according to claim 1, wherein the support rod is substantially vertical.

3. The retractable door assembly according to claim 2, further comprising a ballast member on the second edge of the door, the second edge being the bottom edge of the door.

4. The retractable door assembly according to claim 2, wherein lateral edges of the door are provided with connectors to be releasably connected to lateral edges of the entrance/exit of the portable shelter when the door closes the entrance/exit.

5. The retractable door assembly according to claim 1, wherein the actuation system has an electric motor operatively connected to the support rod by transmission gears so as to transmit rotational motion to the support rod.

6. The retractable door assembly according to claim 5, wherein the actuation system has a transformer to supply the electric motor with 24 V voltage.

7. The retractable door assembly according to claim 1, further comprising a remote control to remotely actuate the actuation system in closing and opening the door.

8. The retractable door assembly according to claim 1, further comprising detectors to detect movement of a vehicle into/out of the portable shelter to automatically close the door.

9. The retractable door assembly according to claim 1, wherein the actuation system has a manual override so as to manually rotate the support rod to open/close the door.

10. A retractable door assembly in combination with a portable shelter comprising:
a portable shelter having a structure and flexible panels secured to the structure to define a volume for accommodating at least one vehicle and at least one entrance/exit; and
a retractable door assembly comprising a door having a panel of flexible material defining a first edge and a second edge, at least one support rod, the door being connected to the support rod at the first edge and rolled onto the support rod, supports operatively connected to ends of the support rod and adapted to connect the support rod on a structure of the portable shelter with respect to the entrance/exit of the portable shelter, such that the support rod is rotatable about its longitudinal axis, and an actuator system operatively connected to the support rod to actuate a rotation of the support rod to deploy the door to close the entrance/exit and retract the door to free the entrance/exit of the portable shelter.

11. The combination according to claim 10, wherein at least a portion of the structure is retractable/expandable along a longitudinal dimension so as to store/deploy the portable shelter.

12. The combination according to claim 10, wherein a roof portion of the structure is removable from a remainder of the structure.

13. The combination according to claim 10, wherein the a portion of the structure away from the entrance/exit is anchored to a surrounding wall or ground.

14. The combination according to claim 10, wherein the support rod is substantially vertical, and further comprising a ballast member on the second edge of the door, the second edge being the bottom edge of the door.

15. The combination according to claim 14, wherein lateral edges of the door and of the entrance/exit are provided with complementary connectors to releasably connect the door to the structure.

16. The combination according to claim 10, wherein the actuation system has an electric motor operatively connected to the support rod by transmission gears so as to transmit rotational motion to the support rod.

17. The combination according to claim 10, further comprising a remote control to remotely actuate the actuation system in closing and opening the door.

18. The combination according to claim 10, further comprising detectors to detect movement of a vehicle into/out of the portable shelter to automatically close the door.

19. The combination according to claim 10, wherein the actuation system has a manual override so as to manually rotate the support rod-to open/close the door.
